(19) United States
(12) Patent Application Publication
(10) Pub. No.: US 2007/0139482 A1
(43) Pub. Date: Jun. 21, 2007

(54) Inkjet printhead

(75) Inventors: You-seop Lee, Yongin-si (KR); Keon Kuk, Yongin-si (KR); Bang-weon Lee, Yongin-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/483,763

(22) Filed: Jul. 11, 2006

(30) Foreign Application Priority Data
Dec. 21, 2005 (KR) 10-2005-0126920

(51) Int. Cl. B41J 2/05

(52) U.S. Cl. 347/65

(57) ABSTRACT

An inkjet printhead is provided. The inkjet printhead includes an ink chamber filled with ink to be ejected, a nozzle through which the ink is ejected from the ink chamber, a manifold to supply the ink to the ink chamber, and a restrictor that connects the ink chamber and the manifold and includes a protrusion formed on an inner wall of the restrictor. A main heater is formed on an inner wall of the ink chamber and generates a main bubble in the ink chamber to eject ink and an auxiliary heater is formed on an inner wall of the restrictor and generates an auxiliary bubble to suppress the main bubble in the restrictor from expanding toward the restrictor. Thus, a refill speed of the ink to the ink chamber is increased and a driving frequency of the inkjet printhead is also increased.

### CROSS-REFERENCE TO RELATED APPLICATIONS

This application claims the priority of Korean Patent Application No. 10-2005-0126920, filed on Dec. 21, 2005, in the Korean Intellectual Property Office, the disclosure of which is incorporated herein in its entirety by reference.

### BACKGROUND OF THE INVENTION

1. Field of the Invention

The present general inventive concept relates to an inkjet printhead, and more particularly, to a thermal inkjet printhead in which the refill speed of ink is increased to increase the driving frequency of the inkjet printhead.

2. Description of the Related Art

An inkjet printhead is an apparatus that ejects minute ink droplets on desired positions of a recording paper in order to print predetermined color images. The inkjet printheads are categorized into two types according to an ink droplet ejection mechanism thereof. The first type is a thermal inkjet printhead that ejects the ink droplets due to an expansion force of ink bubbles generated by thermal energy. The second type is a piezoelectric inkjet printhead that ejects the ink droplets by a pressure applied to ink due to a deformation of a piezoelectric body.

Thermal inkjet printheads are classified into top-shooting inkjet printheads, side-shooting inkjet printheads, and back-shooting inkjet printheads. In the top-shooting inkjet printheads, a growing direction of the ink bubble and an ejection direction of the ink droplets are the same. In the side-shooting inkjet printheads, the growing direction of the ink bubble and the ejection direction of the ink droplets are perpendicular. In the back-shooting inkjet printheads, the growing direction of the ink bubble and the ejection direction of the ink droplets are opposite.

The ink droplet ejection mechanism of the thermal inkjet printhead is as follows. When a current flows through a heater made of a heating resistor, the heater is heated and ink near the heater in an ink chamber is instantaneously heated up to about 300° C. Accordingly, ink bubbles are generated by ink evaporation, and the generated bubbles are expanded to exert a pressure on the ink filled in the ink chamber. Thereafter, the ink droplet is ejected through a nozzle out of the ink chamber.

The conventional thermal inkjet printheads should satisfy the following conditions. First, a manufacturing process of the inkjet printheads must be simple, cost-effective, and suitable for mass production. Second, in order to obtain images of high quality, cross talk between neighboring nozzles must be suppressed, but a distance between the neighboring nozzles must be kept as small as possible. Third, for high speed printing, a period of time in which ink is refilled after being ejected from the ink chamber must be as short as possible. That is, the heated ink and the heater must be rapidly cooled to increase a driving frequency.

FIG. 1 is a cross sectional view illustrating a conventional thermal inkjet printhead. Referring to FIG. 1, a nozzle 50, through which ink is ejected, is formed at an upper portion of an ink chamber 20. The ink chamber 20 is filled with the ink to be ejected. A heater 22 is disposed on a bottom of the ink chamber 20 to heat the ink in the ink chamber 20 to generate a bubble B. An ink channel to supply ink to the ink chamber 20 is formed at a side of the ink chamber 20. The ink channel includes a manifold 40 for supplying the ink and a restrictor 30 that connects the manifold 40 and the ink chamber 20. In the above described configuration, when a current is applied to the heater 22, the ink around the heater 22 is heated and the bubble B is generated and expanded. Due to an expansion force of the bubble B, the ink in the ink chamber 20 is ejected through the nozzle 50. After that, ink is filled again in the ink chamber 20 from the manifold 40 through the restrictor 30.

However, in the above described conventional inkjet printheads, the expansion force of the bubble B acts not only in a direction toward the nozzle 50 but also in a direction toward the restrictor 30, and thus a back flow of ink occurs. That is, the ink in the ink chamber 20 flows toward the restrictor 30 and the manifold 40. The back flow of ink decreases a refill speed of the ink, and as a result, a driving frequency of the inkjet printhead is decreased.

### SUMMARY OF THE INVENTION

The present general inventive concept provides a thermal inkjet printhead to increase a refill speed of an ink and a driving frequency of the thermal inkjet printhead.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept may be achieved by providing an inkjet printhead including an ink chamber filled with ink to be ejected, a nozzle through which ink is ejected from the ink chamber, a manifold to supply ink to the ink chamber, a restrictor that connects the ink chamber and the manifold and includes a protrusion formed on an inner wall thereof, a main heater that is formed on an inner wall of the ink chamber and generates a main bubble in the ink chamber to eject ink, and an auxiliary heater that is formed on the inner wall of the restrictor and generates an auxiliary bubble in the restrictor to suppress the main bubble from expanding toward the restrictor.

The main bubble and the auxiliary bubble may be respectively generated by the main heater and the auxiliary heater at the same time.

The auxiliary heater may be formed between the ink chamber and the protrusion and may be close to the protrusion.

The protrusion may be formed closer to the ink chamber than to the manifold.

The restrictor may be formed at a side of the ink chamber, and the nozzle may be formed at the upper portion of the ink chamber. The main heater and the auxiliary heater may be respectively formed on the bottom of the ink chamber and the restrictor. The protrusion may be formed to protrude to a predetermined height from the bottom of the restrictor.

The foregoing and/or other aspects and utilities of the present general inventive concept may also be achieved by providing an inkjet printhead, including an ink chamber having a nozzle, a manifold to supply ink to the ink chamber, a restrictor disposed between the ink chamber and the manifold to restrict an ink flow between the manifold and the ink chamber, and a protrusion formed on a surface of the restrictor to further limit the ink flow between first and second portions of the restrictor with respect to the protrusion.

The foregoing and/or other aspects and utilities of the present general inventive concept may also be achieved by providing an inkjet printhead, including an ink chamber having a nozzle, a manifold to supply ink to the ink chamber, a restrictor disposed between the ink chamber and the manifold to restrict an ink flow between the ink chamber and the manifold, a main heater disposed in the ink chamber, a protrusion formed in the restrictor; and an auxiliary heater disposed in the restrictor, and an auxiliary heater disposed in the restrictor.

The foregoing and/or other aspects and utilities of the present general inventive concept may also be achieved by providing an inkjet printhead, including an ink chamber having a first height and having a main heater and a nozzle, a manifold having a second height, a restrictor having a third height lower than the first height, and a member formed in the restrictor to control an ink flow within the restrictor.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a cross-sectional view illustrating a conventional inkjet printhead;

FIGS. 2A-2C are cross-sectional views illustrating an inkjet printhead according to an embodiment of the present general inventive concept;

FIG. 3 is a simulation picture illustrating an expanding bubble in a conventional inkjet printhead;

FIG. 4 is a simulation picture illustrating an expanding bubble in an inkjet printhead including a protrusion formed in a restrictor;

FIG. 5 is a simulation picture illustrating an expanding bubble in an inkjet printhead including an auxiliary heater formed on an inner wall of a restrictor; and

FIG. 6 is a simulation picture illustrating an expanding bubble in an inkjet printhead including a protrusion.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

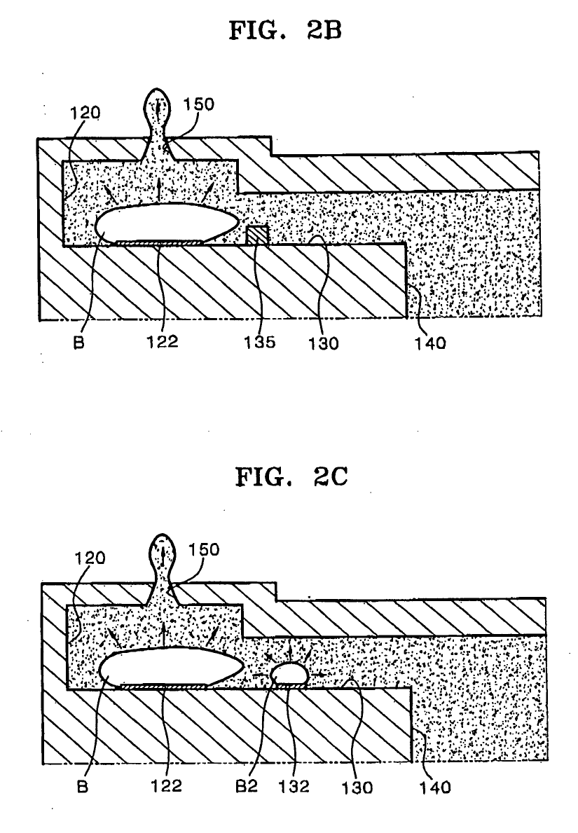

FIGS. 2A-2C are schematic views illustrating a thermal inkjet printhead according to an embodiment of the present general inventive concept. Referring to FIG. 2A, the inkjet printhead includes an ink chamber 120 which is filled with ink to be ejected, a manifold 140 to supply ink to the ink chamber 120, and a restrictor 130 that connects the ink chamber 120 and the manifold 140, and a nozzle 150 through which ink is ejected. The ink chamber 120 has a first height to provide a first path, the manifold 140 has a second height to provide a second path, and the restrictor 130 has a second height lower than the first height to provide a second path between the ink chamber 120 and the manifold 140. Referring to FIG. 2B, the inkjet printhead includes the ink chamber 120, the restrictor 130, the manifold 140, and the protrusion 135. Referring to FIG. 2C, the inkjet printhead includes the ink chamber 120, the restrictor 130, the manifold 140, and the auxiliary heater 132 to form the bubble B2.

A main heater 122 may be formed on a bottom of the ink chamber 120. The main heater 122 heats the ink in the ink chamber 120 to generate a main bubble B1. Due to an expansion force of the main bubble B1, the ink in the ink chamber 120 is ejected through the nozzle 150 to an outside. The main heater 122 may also be formed on another inner wall in the ink chamber 120. The nozzle 150 may be formed at an upper portion of the ink chamber 120.

The restrictor 130 provides the third path through which ink is supplied from the manifold 140 to the ink chamber 120. The restrictor 130 may be connected to a side of the ink chamber 120. The restrictor 130 may also be formed to be connected to the bottom of the ink chamber 120 instead of the side of the ink chamber 120. A protrusion 135 is formed on a bottom of the restrictor 130 to a fourth height to provide a fourth path narrower than the third path of the restrictor 130. The protrusion 135 may be formed on another inner wall of the restrictor 130 instead of the bottom of the restrictor 130. The protrusion 135 may protrude from the surface of the restrictor 130 toward another surface of the restrictor 130 by the fourth height to provide the fourth path having a fifth height less than the third height. The protrusion 135 prevents a back flow of ink by preventing the main bubble B1 generated by the main heater 122 from expanding toward the restrictor 130, together with an auxiliary heater 132, which will be described later. The height of the protrusion 135 may be determined according to a design of the inkjet printhead. The protrusion 135 may be formed closer to the ink chamber 120 than to the manifold 140 in the restrictor 130 to efficiently prevent the back flow of ink from the ink chamber 120. The protrusion 135 may also be formed on the inner wall of the ink chamber 120 which may be close to the restrictor 130.

The auxiliary heater 132 may be formed on the bottom of the restrictor 130 to heat the ink near the restrictor 130 to generate an auxiliary bubble B2. The auxiliary heater 132 may also be formed on the bottom of the restrictor 130 disposed between the ink chamber 120 and the protrusion 135. It is possible that the auxiliary heater 132 is formed between the protrusion 135 and the manifold 140. The auxiliary heater 132 generates the auxiliary bubble B2 at a same time when the main heater 122 generates the main bubble B1. An expansion force of the auxiliary bubble B2, together with the protrusion 135, prevent the main bubble B1 from expanding toward the restrictor 130 to prevent the back flow of ink. To efficiently prevent the back flow of ink, the auxiliary heater 132 may be disposed close to the protrusion 135. The auxiliary heater 132 may also be formed on another inner wall of the restrictor 130 instead of the bottom of the restrictor 130.

In the inkjet printhead according to the present embodiment of the present general inventive concept, when the ink chamber 120, the restrictor 130, and the manifold 140 are filled with ink and a current is applied at the same time to the main heater 122 and the auxiliary heater 132, the main bubble B1 and the auxiliary bubble B2 are generated and expanded at the same time. The main bubble B1 is generated and expanded by the heating of the main heater 122 formed on the inner wall of the ink chamber 120 to eject the ink through the nozzle 150 to the outside. The auxiliary bubble B2 is generated and expanded by the heating of the auxiliary heater 132 formed near the protrusion 135 of the restrictor 130, and thus prevents the main bubble B1 from expanding toward the restrictor 130. The auxiliary bubble B2 is prevented by the protrusion 135 from expanding toward the manifold 140. Thus, in the inkjet printhead in the present embodiment of the present general inventive concept, the back flow of ink, that is, the ink in the ink chamber 120 flowing toward the restrictor 130, is prevented and the refill speed of the ink to the ink chamber 120 can be increased. The inkjet printhead may have a common electrode (not shown) connected to the heater 122 and the auxiliary heater 132 or may have separate electrodes to be connected to the heater 122 and the auxiliary heater 132.

The following simulation results illustrate how the back flow of ink is efficiently prevented in the inkjet printhead of the present embodiment of the present general inventive concept compared to the conventional inkjet printhead.

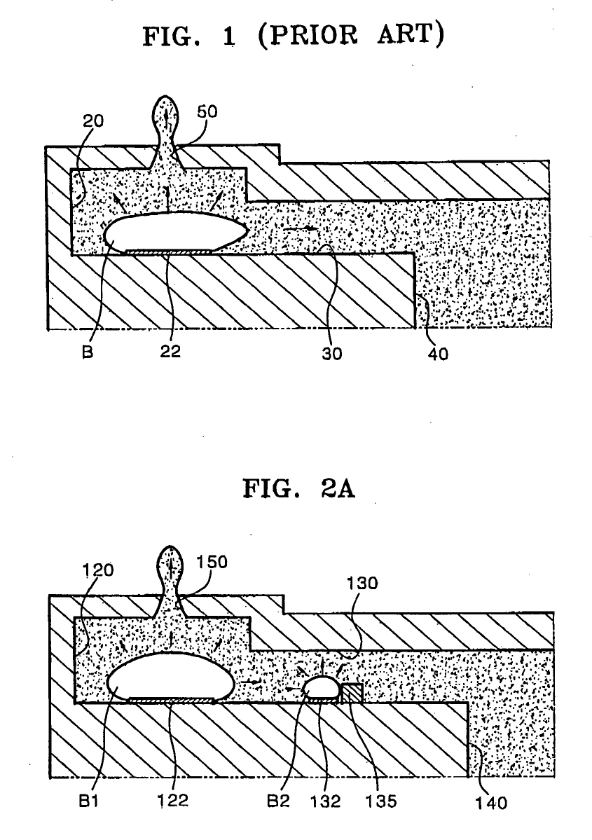

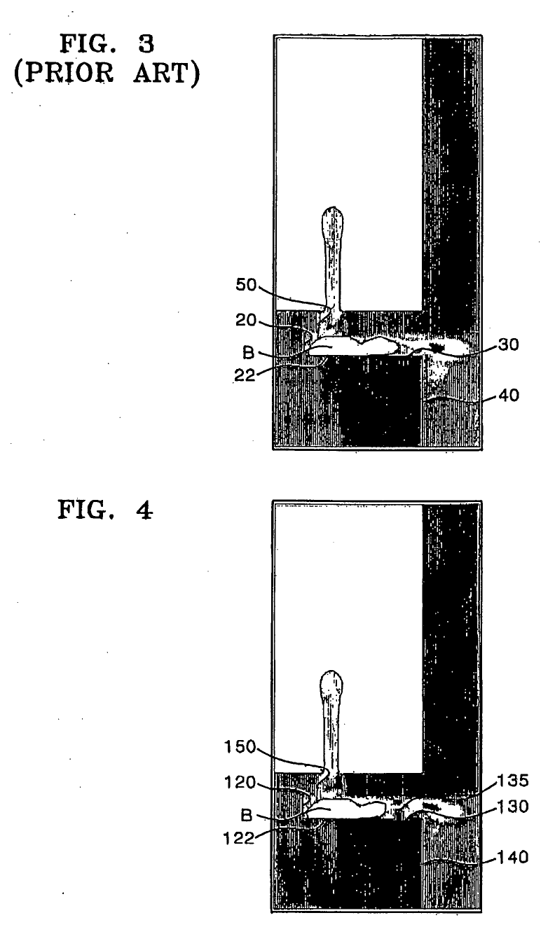

FIG. 3 is a simulation picture illustrating an expanding bubble B in the conventional inkjet printhead of FIG. 1. Referring to FIG. 3, the bubble B generated in an ink chamber 20 is expanded toward a restrictor 30, and thus, a back flow of ink F1, that is, the ink flowing toward the restrictor 30, occurs.

FIG. 4 is a simulation picture illustrating the expanding bubble B1 in an inkjet printhead including the protrusion 135 formed in the restrictor 130. Referring to FIGS. 2B and 4, the protrusion 135 prevents the bubble B1 from expanding toward the restrictor 130 and thus a back flow of ink is reduced compared to the inkjet printhead in FIG. 3.

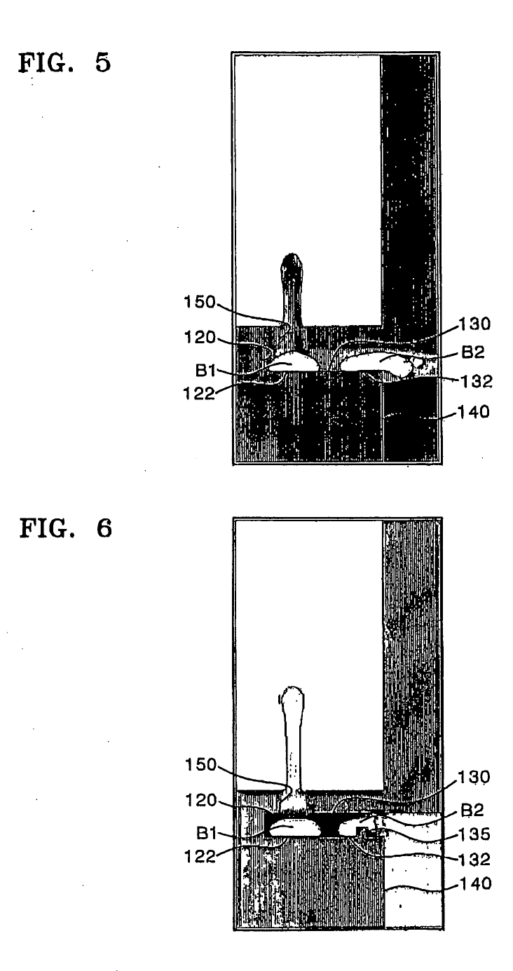

FIG. 5 is a simulation picture illustrating an expanding bubble B1 in an inkjet printhead including the auxiliary heater 132 formed on the inner wall of a restrictor 130. Referring to FIGS. 2C and 5, the main bubble B1 generated by the main heater 122 is suppressed by the auxiliary bubble B2 generated by the auxiliary heater 132 from expanding toward the restrictor 130. The auxiliary bubble B1 expands not only toward the ink chamber 120 but also toward the manifold 140.

FIG. 6 is a simulation picture illustrating the expanding bubble B1 in the inkjet printhead according to an embodiment of the present general inventive concept. Referring to FIGS. 2A and 6, the main bubble B1 generated by the main heater 122 is suppressed by the auxiliary bubble B2 generated by the auxiliary heater 132 from expanding toward the restrictor 130 and the auxiliary bubble B2 is suppressed by the protrusion 135 from expanding toward the manifold 130. Thus, a back flow F4 of ink is considerably reduced.

As described above, in an inkjet printhead according to the present general inventive concept, an auxiliary heater and a protrusion are formed in a restrictor to efficiently prevent a back flow of ink, that is, an ink flowing toward the restrictor. Thus, a refill speed of the ink to an ink chamber is increased and a driving frequency of the inkjet printhead is increased.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An inkjet printhead, comprising:
an ink chamber filled with ink to be ejected;
a nozzle through which ink is ejected from the ink chamber;
a manifold to supply ink to the ink chamber;
a restrictor that connects the ink chamber and the manifold and includes a protrusion formed on an inner wall thereof;
a main heater that is formed on an inner wall of the ink chamber and generates a main bubble in the ink chamber to eject ink; and
an auxiliary heater that is formed on the inner wall of the restrictor and generates an auxiliary bubble in the restrictor to suppress the main bubble from expanding toward the restrictor.

2. The inkjet printhead of claim 1, wherein the main bubble and the auxiliary bubble are respectively generated by the main heater and the auxiliary heater at a same time.

3. The inkjet printhead of claim 1, wherein the auxiliary heater is formed between the ink chamber and the protrusion.

4. The inkjet printhead of claim 3, wherein the auxiliary heater is formed close to the protrusion.

5. The inkjet printhead of claim 3, wherein the protrusion is formed closer to the ink chamber than to the manifold.

6. The inkjet printhead of claim 3, wherein the restrictor is formed at a side of the ink chamber.

7. The inkjet printhead of claim 6, wherein the nozzle is formed at an upper portion of the ink chamber.

8. The inkjet printhead of claim 6, wherein the main heater and the auxiliary heater are respectively formed on a bottom of the ink chamber and a bottom of the restrictor.

9. The inkjet printhead of claim 8, wherein the protrusion is formed to protrude to a predetermined height from the bottom of the restrictor.
